(19) United States
(12) Patent Application Publication
(10) Pub. No.: US 2014/0009486 A1
(43) Pub. Date: Jan. 9, 2014

(54) DISPLAY DEVICE, AND CONTROL METHOD FOR DISPLAY DEVICE

(71) Applicant: Katsuyuki Matsui, Tokyo (JP)

(72) Inventor: Katsuyuki Matsui, Tokyo (JP)

(73) Assignee: NEC Display Solutions, Ltd., Tokyo (JP)

(21) Appl. No.: 14/001,659

(22) PCT Filed: Feb. 28, 2011
(86) PCT No.: PCT/JP2011/054480

§ 371 Date: Sep. 16, 2013

(51) Int. Cl. G06T 11/00

(52) U.S. Cl. CPC G06T 11/001
USPC 345/590

(57) ABSTRACT

A display device includes a reference storage unit which stores a reference value of color gamut resulting from a reference color sensor measuring primary colors displayed on the screen; a difference calculation part which calculates a difference between the reference value of color gamut stored in the reference value storage unit and the measured value of color gamut resulting from a correcting color sensor measuring primary colors displayed on the screen; and an output part which outputs an alert to notify an abnormality of the correcting color sensor when the difference between the measured value of color gamut and the reference value of color gamut becomes equal to or greater than a predetermined threshold.

### TECHNICAL FIELD

The present invention relates to a display device equipped with a device which detects chromaticity and luminance of an image displayed on the screen of a display device with an external sensor so as to correct chromaticity and luminance, and a control method for the display device.

### BACKGROUND ART

In order to correct a display device, a sensor for detecting chromaticity and luminance of an image displayed on the screen may exclusively adopt a simple color sensor (hereinafter, referred to as a simple sensor). A simple sensor as such is an essential component that may determine the performance of a display device.

For this reason, it is preferable to alert users that a colorimetry error regarding the measured chromaticity or luminance has become higher than a certain value due to aged deterioration or individual differences between simple sensors, or to alert users to changes of conditions.

However, in a display device which displays primary colors (e.g. three primary colors R, G, and B) so as to measure the displayed colors with a simple sensor, even when a simple sensor produces an output value (e.g. X, Y, and Z values defined according to the XYZ colorimetric system of CIE1931) significantly different from the preset reference value, it is impossible to determine whether the cause of error depends on a display error of a display device or a colorimetry error of a simple sensor.

This may occur owing to a display device and a simple sensor both having low reliability. In the related technology, Patent Literature 1 discloses a technology for correcting chromaticity of a display device based on an output value of a sensor.

### CITATION LIST

### Patent Literature

Patent Literature 1: Japanese Patent Application Publication No. 2005-49609

### SUMMARY OF INVENTION

### Technical Problem

The problem to be solved is that, due to low reliability of a display device and a simple sensor, when the simple sensor produces an output value significantly different from the preset reference value, it is impossible for a user of the display device to determine whether the cause of error depends on a display error of the display device or a colorimetry error of the simple sensor.

### Solution to Problem

The present invention is directed to a display device having a display for displaying video, characterized by comprising: a reference value storage unit which stores a reference value of color gamut resulting from a reference color sensor measuring primary colors displayed on the display; a difference calculation part which calculates a difference between a measured value of color gamut resulting from a color sensor, which a user of the display device uses to correct the display device, measuring primary colors displayed on the display and the reference value of color gamut stored in the reference value storage unit; and an output part which outputs an alert to notify the user of an abnormality of the color sensor when the difference calculated by the difference calculation part becomes equal to or greater than a preset allowable value during a user's correcting operation.

The display device of the present invention is characterized in that the reference color sensor and the color sensor for correcting the display device are each defined as a sensor which measures colors of the display of the display device so as to output X, Y, and Z based on an XYZ colorimetric system of CIE1931 according to the International Commission on Illumination, wherein the measured value of color gamut and the reference value of color gamut, which are used for calculation with the difference calculation part, are each defined as a ratio of X, Y, Z which is produced by converting the X, Y, and Z with the difference calculation part.

The present invention is directed to a control method for a display device which outputs an alert to notify a user of an abnormality of a color sensor which is used by a user of the display device for correcting the display device and characterized by comprising: a first step for measuring primary colors displayed on a display of the display device by use of a reference color sensor, thus storing a reference value of color gamut, resulting from measurement, in a reference value storage unit; a second step for calculating a difference between a measured value of color gamut, resulting from a color sensor, which the user of the display device uses to correct the display device, measuring primary colors displayed on the display, and the reference value of color gamut stored in the reference value storage unit; and a third step for putting out an alert to notify the user of an abnormality of the color sensor when the difference becomes equal to or greater than a preset allowable value during a user's correcting operation.

### Advantageous Effects of Invention

The present invention is advantageous in that, when a simple sensor used for color correction of a display device produces an output value significantly different from the preset reference value, it is possible to alert a user of the display device as to whether or not the cause of error depends on a colorimetry error of the simple sensor, and therefore the user of the display device is allowed to determine the availability of the simple sensor.

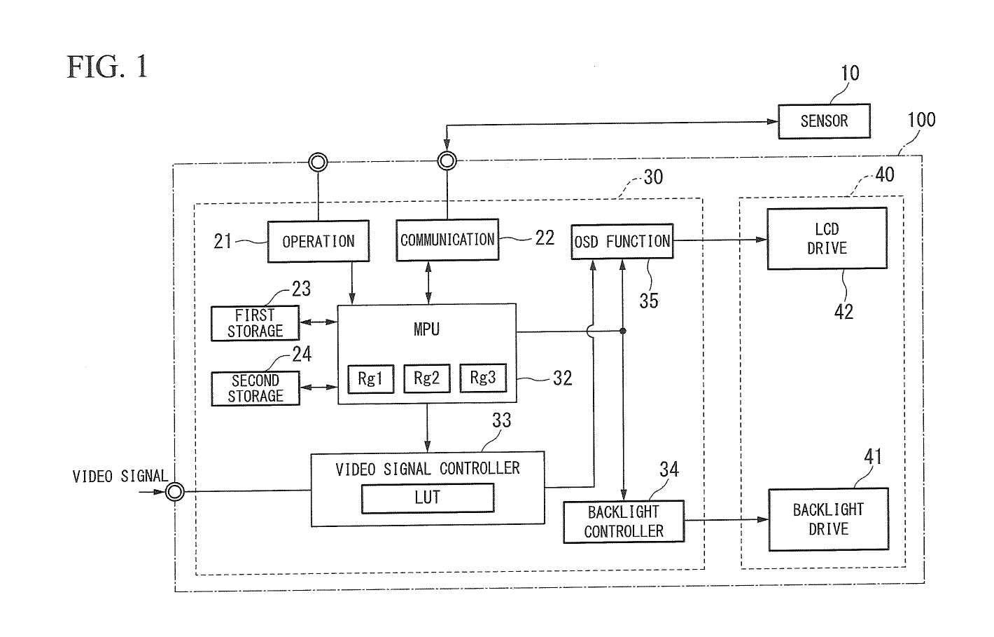

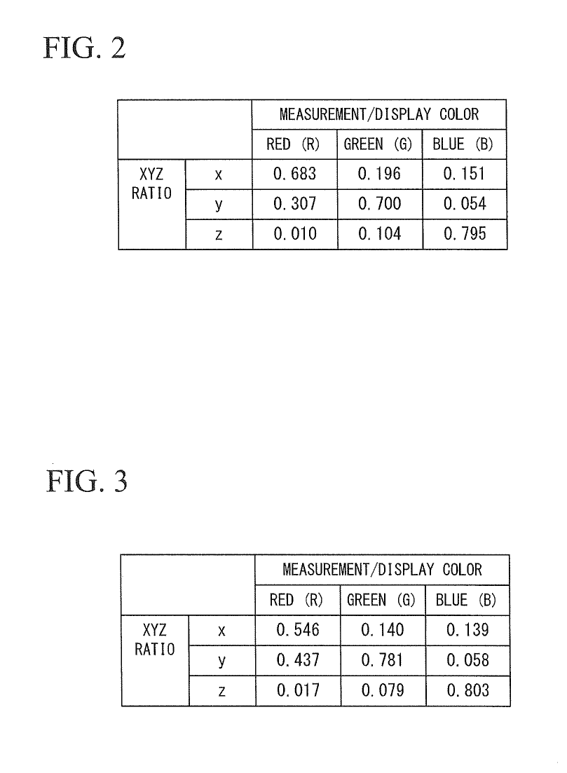

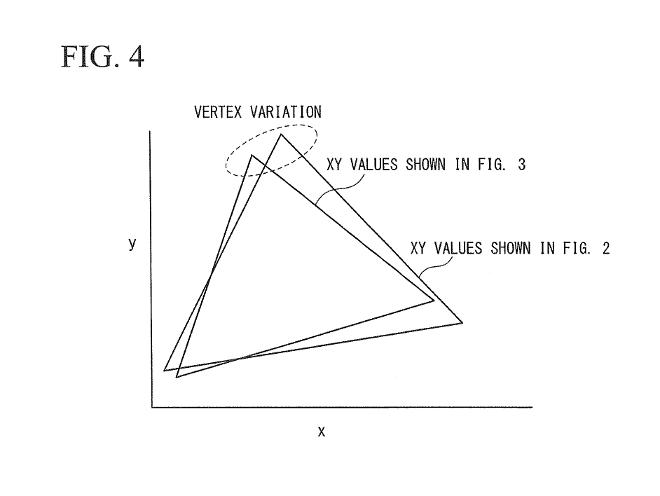

### BRIEF DESCRIPTION OF DRAWINGS

[FIG. 1] A block diagram showing the configuration of a display device according to one embodiment of the present invention.

[FIG. 2] A drawing illustrating a data configuration of data stored in a first storage unit 23 shown in FIG. 1.

[FIG. 3] A drawing illustrating x, y, and z values calculated by a MPU 32 shown in FIG. 1.

[FIG. 4] A chromaticity diagram illustrating another determination method of the MPU 32 shown in FIG. 1.

### DESCRIPTION OF EMBODIMENT

Hereinafter, a display device according to one embodiment of the present invention will be described with reference to the drawings. FIG. 1 is a block diagram showing a liquid crystal display device 100 adopting a display device according to one embodiment of the present invention.

The liquid crystal display device 100 includes a control unit 30 and a liquid crystal display 40.

The control unit 30 displays an image corresponding to a video signal input thereto with the liquid crystal display 40.

The liquid crystal display 40 is equipped with a liquid crystal panel (not shown), which displays an image according to luminance and chromaticity specified by the control unit 30.

FIG. 1 shows a sensor 10 in association with the liquid display device 100. The sensor 10 converts three primary colors, R (red), G (Green), and B (Blue) ascribed to the RGB colorimetric system displayed with the liquid crystal display 40, into X, Y, and Z values (XYZ values) ascribed to the XYZ colorimetric system, thus outputting them. The XYZ colorimetric system was determined along with the RGB colorimetric system by the International Commission on Illumination (CIE: Commission Internationaled' Eclairage) in 1931.

The sensor 10 represents a reference sensor 10a (i.e. a sensor serving as a reference) used by a user who manufactures the display device 100, and a simple sensor 10b (i.e. a simple sensor) used by a use who purchases the display device 100.

For example, the reference sensor 10a and the simple sensor 10b are each configured of three monochromatic color filters of red (whose center wavelength is about 620 nm (nano-meter)), blue (whose center wavelength is about 555 nm), and green (whose center wavelength is about 450 nm), three photodiodes (i.e. optical monochromatic receivers included in the reference sensor 10a and the simple sensor 10b), an AD (Analog Digital) converter, and an operator.

The control unit 30 includes an operation part 21, a communication part 22, a first storage unit 23, a second storage unit 24, an MPU 32, a video signal controller 33, an OSD function part 35, and a backlight controller 34.

Upon receiving a user's instruction, the operation part 21 outputs a signal, corresponding to the instruction, to the MPU 32 (MPU: Micro Processor Unit).

The communication part 22 outputs a control signal representing an instruction for starting color measurement with the MPU 32 to the reference sensor 10a or the simple sensor 10b. Upon receiving the control signal, the reference sensor 10a or the simple sensor 10b performs color measurement on the screen of the liquid crystal display 40, thus outputting X, Y, and Z values representing color measurement results to the communication part 22. The communication part 22 sends X, Y, and Z values to the MPU 32. For example, a control signal and X, Y, and Z values are transmitted via a USB cable laid between the communication part 22 and the reference sensor 10a or the simple sensor 10b.

The MPU 32 has a function of controlling various parts of the display device 100 and a function of controlling transmission of a control signal and X, Y, Z values between the communication part 22 and the reference sensor 10a or the simple sensor 10b in response to an instruction of a user (i.e. a manufacturer of the display device 100, or a purchaser of the display device 100) initiating a display correction process.

For example, the MPU 32 converts X, Y, and Z values, which are output from the reference sensor 10a in response to an instruction of a user (i.e. a manufacturer of the display device 100) initiating a display correction process, into x, y, and z values rendered via the xyz colorimetric system defined in CIE1931, which are stored in the first storage unit.

Additionally, the MPU 32 converts XYZ values, which are output from the simple sensor 10b in response to an instruction of a user (i.e. a purchaser of the display device 100) initiating a display correction process, into x, y, and z values. Subsequently, it compares the converted x, y, and z values with the x, y, and z values stored in the first storage unit 23, thus determining whether or not the simple sensor 10b is degraded.

The first storage unit 23 stores the x, y, and z values converted by the MPU 32 in connection with three primary colors R, G, and B.

The second storage unit 24 stores a reference value (i.e. a preset allowable value) used for comparative determination.

Under control of the MPU 32, the video signal controller 33 outputs a video signal, which is input thereto from an external device of the display device 100, to the OSD function part 35.

Various display devices such as CRT (Cathode Ray Tube), liquid crystal displays (LCD), and plasma display panels (PDP) have inherent gamma characteristics and chromaticity characteristics depending on their own characteristics ascribed to display devices. Herein, gamma characteristics of a display device represent the relationship between an input signal level and an output luminance of a display device. Additionally, chromaticity characteristics represent chromaticity regarding three or more primary colors (e.g. RGB+white) ascribed to display devices. Generally, display devices utilize three primary colors of RGB; hence, chromaticity characteristics may represent RGB chromaticity.

These characteristics depend on types of display devices, and therefore the types of CRT, LCD, and PDP may significantly differ from each other in terms of gamma characteristics as well as chromaticity characteristics.

When the MPU 32 issues a video signal adjusting instruction, the video signal controller 33 changes chromaticity (or performs gamma correction and chromaticity correction) with respect to a video signal input thereto with reference to a lookup table LUT storing gamma characteristics and chromatic characteristics of a display device, thus outputting the changed video signal to the OSD function part 35.

Under control of the MPU 32, the video signal controller 33 outputs a test video signal (i.e. maximum gradation regarding each of three primary colors R, C_{T} and B for the display device 100) when a user measures chromaticity and luminance on the display device 100 at factory shipment by use of the reference sensor 10a or when a user measures chromaticity and luminance on the display device 100 by use of the simple sensor 10b.

The backlight controller 34 changes a control signal driving the backlight drive unit 41 in response to an instruction of the MPU 32. For example, the backlight controller 41 changes an effective value of a current supplied to an inverter when a cold-cathode fluorescent lamp is used as a light source configuring the backlight of the liquid crystal display 40 and driven using a current-controlled optical inverter. It changes a pulse width or a peak value of a voltage supplied to an LED drive circuit when an LED is used as a light source.

The OSD function part 35 (an output part) outputs the corrected video signal, output from the video signal controller 33, to the LCD drive unit 42 so as to drive an liquid crystal panel via the LCD drive unit 42, thus displaying various pieces of information.

Additionally, the OSD function part 35 outputs an alert based on the determination result of the MPU 32 when the MPU 32 determines that the measurement result of chromaticity and luminance using the reference sensor 10a for the display device 100 at factory shipment does not match the measurement result of chromaticity using the simple sensor 10b by a user of the display device 100. As a method for putting out an alert, it is possible to output an alert at a certain position on the screen of the liquid crystal display 40 or to output an alert for the OSD superimposed on a video signal.

The liquid crystal display 40 has the backlight drive unit 41 and the LCD drive unit 42 so as to display an image on the liquid crystal panel (not shown) in response to instructions from these drive units. The backlight drive unit 41 turns on the backlight to achieve brightness in response to a control signal supplied from the backlight controller 34. The LCD drive unit 42 drives the liquid crystal display 40 to display an image in accordance with a video signal output from the OSD function part 35.

The liquid crystal display 40 is equipped with a color filter using three primary color filters (R, G, and B filters), including a red (R) filter, a blue (B) filter, and a green (G) filter, for each pixel in the liquid crystal display panel.

Generally, it is necessary to employ different materials in primary colors R, and B in order that a backlight source can emit white light. For example, fluorescent substances serving as R, G, and B are enclosed in a generally-used cold-cathode tube (CCFL) so as to emit white light. Alternatively, when a white LED serves as a light source, a white LED irradiates blue light, emitted from a blue LED, onto yellow-colored fluorescent substances (serving as red and blue), thus emitting white light.

The LED drive unit 42 adjusts transmissivity of color filters installed in the liquid crystal panel in response to the corrected video signal input from the OSD function part 35. Subsequently, a color filter, using three primary color filters, which is adjusted in transmissivity transmits white light, emitted from the light source driven by the backlight drive unit 41, therethrough, thus displaying video having the corrected chromaticity and luminance on the liquid crystal panel.

Next, the reason why the MPU 32 detects a colorimetry error due to degradation of the simple sensor 100b based on x, y, and z values in the display device 100 having the above configuration will be described.

The inventor's study regarding the present invention reveals a fact that, among optical materials configuring the display device 100 and the simple sensor 10b, the “sensor receiver” of the simple sensor 10b has the highest optical stability while the optical stability may be decreased in the order of the “sensor receiver”, the “color filter”, and the “light source”. As described above, the “color filter” indicates X, Y, and Z filters in the simple sensor 10b or R, G, and B filters in the liquid crystal display 40. Additionally, the “light source” indicates a CCFL or a white LED in the liquid crystal display 40.

The “sensor receiver” is made up of a metal, such as silicon, and therefore the optical characteristic thereof is sufficiently stable in comparison with the optical characteristics of the other optical components. That is, the simple sensor 10b (i.e. a simple sensor) has high reliability with respect to the linearity (i.e. an output voltage versus an input luminance) depending on the characteristic of the sensor receiver.

The “color filters” are largely classified into two types as described above, wherein the display device 100 employs R, G, and B filters while the simple sensor 10b employs X, Y, and Z filters.

Generally speaking, X, Y, and Z filters tend to have fragile physical characteristics in compliance with the CIE1931 standard. In X, Y, and Z filters, organic coloring matters configuring color filters may undergo chemical changes due to exposure to ultraviolet rays or due to hydrolysis depending on humidity, and therefore they may undergo degradation, such as color degradation, color fadeout, and yellow discoloration, with ease. Degradation characteristics depend on filter materials; hence, X, Y, and Z filters have different degradation characteristics.

That is, X, Y, and Z filters are characterized in that outputs X, Y, and Z may be varied (e.g. a ratio of X, Y, and Z outputs, such as X/Y, may be varied) independently due to aged degradation of color filters.

The inventor of the present invention considers that a main cause of degradation or failure of the simple sensor 10b is a variation of a ratio of outputs X, Y, and Z in the simple sensor 10b because X, Y, and Z filters have different degradation characteristics.

As described above, it is necessary for the “light source” to employ different materials for primary colors R, G, and B respectively. The “light source” driven by electric power undergoes a high energy density and self-heating, and therefore it is the most degradable one among optical components.

Owing to properties of light sources which possess different degradation characteristics depending on materials, they may cause variations in terms of the luminance of three primary colors R, G, and B and a ratio of outputs R, G, and B (e.g. a ratio of an output B to an output R). For example, they may cause aged degradation such as yellow discoloration of white chromaticity on the screen of the display device 100.

The inventor of the present invention considers that a main cause of aged degradation of the display device 100 lies in properties of light sources which possess different degradation characteristics depending on materials generating three primary colors R, and B included in while light emitted therefrom. For this reason, it is necessary to correct chromaticity and luminance of the display device 100 with the simple sensor 10b.

Next, a principle of the display device 100, having the above configuration, which compares x, y, and z values, which are produced by converting X, Y, and Z values output from the simple sensor 10b, with x, y, and z values stored in the first storage unit 23 so as to determine whether or not the simple sensor 10b is degraded will be described.

It is possible to express x, y, and z values by use of X, Y, and Z values output from the sensor 10 (i.e. the reference sensor 10a, and the simple sensor 10b) in the following manner.

x=X/(X+Y+Z), y=Y/(X+Y+Z), z=1−(x+y)

The x, y, z values (hereinafter, xy values) represents ratios between outputs X, Y, and Z from the sensor 10 (i.e. the reference sensor 10a, and the simple sensor 10b). For example, x can be expressed as (1−y−z), which represents a ratio between outputs X, Y, and Z. Hereinafter, a ratio between outputs X, Y, and Z will be referred to as an XYZ ratio.

When primary colors at color gamut edges in the display device 100 (i.e. maximum gradations of three primary colors R, G, and B) are displayed on the liquid crystal display 40, the liquid crystal display 40 may display colors with luminance corresponding to one primary color (or a single color) included in white light emitted from the “light source”.

In order to display a three primary color R, for example, G and B components included in white color emitted from the light source are shut out via the “color filter” and may not reach the simple sensor 10b.

For this reason, a variation of a ratio between outputs R, G, and B, which may occur on the screen of the display device 100 due to aged deterioration of the “light source” does not affect an XYZ ratio of the simple sensor 10b which one of three colors is reachable.

Additionally, a luminance reduction, which may occur on the screen of the display device 100 due to aged deterioration of the “light source”, appears in common among outputs X, Y, and Z of the simple sensor 10b, which do not affect an XYZ ratio of the simple sensor 10b.

When primary colors are displayed on the liquid crystal display 40, an XYZ ratio of the simple sensor 10b will not be affected by aged deterioration of the display device 100 and therefore maintained constant unless the simple sensor 10b is not degraded.

Other factors, other than degradation of the “light source” installed in the display device 100, among factors causing a variation of an XYZ ratio are characteristic degradation of the “sensor receiver” of the simple sensor 10b, and characteristic degradation of X, Y, and Z filters. Herein, the “sensor receiver” having high reliability should be precluded from these factors; hence, a variation of an XYZ ratio may reflect failure or degradation of the “color filter” in the simple sensor 10b.

Thus, the display device 100 of the present invention is designed such that the MPU 32 compares x, y, and z values, which are produced by converting X, Y, and Z values output from the simple sensor 10b, with x, y, and z values stored in the first storage unit 23, thus determining whether or not the simple sensor 10b is degraded.

For this reason, even when a user of the display device 100 does not carry the reference sensor 10a serving as reference, the user may carry and use the simple sensor 10b to perform color measurement on the display device 100, thus determining whether or not the output of the simple sensor 10b is reliable. Then, if it is unreliable, the user may determine whether to use the simple sensor 10b, i.e. the user may determine the availability of the simple sensor 10b.

Subsequently, Steps 1 through Step 8 configuring a flow of processing for detecting the characteristic degradation of the “color filter” in the simple sensor 10b will be described with reference to FIGS. 2 and 3.

FIG. 2 is a drawing illustrating a data configuration of data stored in the first storage unit 23. The first storage unit 23 includes items “measurement/display color”, and “XYZ ratio”. This drawing is a two-dimensional table illustrating x, y, and z values (or an XYZ ratio), which the MPU 32 calculates based on X, Y, and Z values measured by the reference sensor 10a, with respect to three primary colors R, G, and B. For example, it shows that 0.546 is stored as an x value of a three primary color R in the first storage unit 23.

FIG. 3 is a two-dimensional table illustrating x, y, and z values, which the MPU 32 calculates based on X, Y, and Z values measured by the simple sensor 10b, with respect to three primary colors R, G, and B.

According to Step 1 through Step 4, as described below, the color gamut of the display device 100 is stored using the reference sensor 10a in the first storage unit 23 before factory shipment of the display device 100.

A user (i e a manufacturer of the display device 100) connects the reference sensor 10a to the communication part 22 via a USB cable, and then inputs an instruction for initiating a display correction process with the MPU 32 by way of the operation part 21.

(Step 1)

First, the MPU 32 transmits a test signal, corresponding to a three primary color R serving as the color gamut edge of the display device 100, to the video signal controller 33. The video signal controller 33 controls the OSD function part 35 so as to display an image, corresponding to the maximum gradation of R, on the liquid crystal display 40 via the LCD drive unit 42.

Thus, it is possible to display an R-colored image entirely on the screen of the liquid crystal display 40.

(Step 2)

The MPU 32 receives X, Y, and Z values, output from the reference sensor 10a, via the communication part 22 and then temporarily stores ternary values, e.g. X, Y, and Z values for R, in a first register Rg1 which is arranged for each of R, G, and B inside the MPU 32.

After an R-colored image is displayed for a predetermined period of time so as to obtain X, Y, and Z values, the control unit 30 executes Steps 1 and 2 with respect to three primary colors G, B so as to obtain X, Y, and Z values for each color, thus temporarily storing X, Y, and Z values in the first register Rg1 with respect to each of G and B.

(Step 3)

The MPU 32 reads X, Y, and Z values from the first register Rg1 with respect to each of the obtained primary colors so as to calculate x, y, and z values, defined in the x, y, z colorimetric system of CIE1931 based on these values, thus storing x, y, and z values for each primary color in a second register Rg2 which is arranged with respect to each of R, G, and B.

(Step 4)

The MPU 32 reads x, y, and z values from the second register Rg2 with respect to each of R, G, and B, thus storing these data in the first storage unit 23.

As shown in FIG. 2, the first storage unit 23 stores x=0.683, y=0.307, and z=0.010 in connection with the primary color R displayed on the display device 100. Additionally, the first storage unit 23 stores x=0.196, y=0.700, and z=0.104 in connection with the primary color G displayed on the display device 100. Moreover, the first storage unit 23 stores x=0.151, y=0054, and z=0.759 in connection with the primary color B displayed on the display device 100.

The first storage unit 23 is configured of a non-volatile memory such as EEPROM so as to store x, y, and z values for each primary color. It is prohibited to rewrite the stored x, y, and z values with other values after the factory shipment of the display device 100.

Next, when a user (i.e. a purchaser of the display device 100) corrects the color gamut of the display device 100 by use of the simple sensor 10b after the factory shipment of the display device 100, it is necessary to perform determination and comparison between the stored data of the first storage unit 23 and the measured data of the simple sensor 10b by way of Steps S5 through S8.

A user (i.e. a purchaser of the display device 100) connects the simple sensor 10b to the communication part 22 via a USB cable and then inputs an instruction for initiating a display correction process to the MPU 32 via the operation part 21.

(Step 5)

Through executing a step similar to Step S11, it is possible to display an R-colored image entirely on the screen of the liquid crystal display 40.

(Step S6)

The MPU 32 receives X, Y, and Z values, output from the simple sensor 10b, via the communication part 22 so as to temporarily store ternary values, e.g. X, Y, and Z values for R, in the first register Rg1 (e.g. the same register as Step 2) which is arranged with respect to each of R, G, and B inside the MPU 32.

After an R-colored image is displayed for a predetermined period of time so as to obtain X, Y, and Z values, the controller 30 executes Steps 1 and 2 with respect to three primary colors G, B so as to obtain X, Y, and Z values for each color, thus temporarily storing X, Y, and Z values in the first register Rg1 with respect to each of G and B.

(Step 7)

The MPU 32 reads X, Y, and Z values from the first register Rg1 with respect to each of the obtained primary colors so as to calculate x, y, and z values, defined in the xyz colorimetric system of CIE1931, based on these values, thus storing x, y, and z values for each primary color in the second register Rg2 (e.g. the same register as Step 3) which is arranged with respect to each of R, G, and B inside the MPU 32.

As shown in FIG. 3, the MPU 32 calculates x=0.546, y=0.437, and z=0.017 for the primary color R displayed on the display device 100 so as to store them in the second register Rg2. Additionally, the MPU 32 calculates x=0.140, y=0.781, and z=0.079 for the primary color G displayed on the display device 100 so as to store them in the second register Rg2. Moreover, the MPU 32 calculates x=0.139, y=0.058, and z=0.803 for the primary color G displayed on the display device 100 so as to store them in the second register Rg2.

(Step 8)

The MPU 32 reads x, y, and z values from the second register Rg with respect to each of R, G, and B, calculates differences between these data and data stored in the first storage unit 23, and stores Δx, Δy, Δz for each primary color in a third register Rg3 which is arranged with respect to each of R, G, and B.

For example, an x value used for displaying an R color on the display device 100 is set to x=0.546, while the counterpart x value stored in the first storage unit 23 is set to x=0.683. The MPU 32 calculates an absolute value Δx=0.137 representing a difference between these data so as to store it in the third register Rg3.

Next, the MPU 32 determines whether or not data stored in the third register Rg3 is equal to or less than preset data of the second storage unit 24.

For example, the preset data of the second storage unit 24 is set to 0.01 representing a variation of color gamut (or an allowable variation) which is determined upon presumption of aged deterioration (e.g. degradation of the light source) of the display device 100 which is used for one thousand hours.

The above example shows Δx>0.01 with respect to an R color displayed on the display device 100, which may exceed an allowable variation.

As described above, Δx exceeding an allowable variation may not occur due to aged deterioration of the display device 100, such as the light source, but due to failure or degradation of the simple sensor 10b.

When one of data stored in the third register Rg3 is found to be greater than the preset data of the second storage unit 24, the MPU 32 outputs a control signal to the OSD function part 35 in order to notify a user of an abnormality of the simple sensor 10b. Upon receiving the control signal, the OSD function part 35 drives the liquid crystal panel via the LCD drive unit 42 so as to display an OSD message indicating “it is inappropriate to use the measured value of the simple sensor 10b for correction” or “a failure of the simple sensor 10b” on the screen, thus notifying a user of a failure (degradation) of the simple sensor 10b.

In this connection, when all the data stored in the third register Rg3 are below the preset data of the second storage unit 24, it is possible to display an OSD message indicating “it is appropriate to use the measured value of the simple sensor 10b for correction” or “the simple sensor 10b is operating normally”.

In another embodiment, it is possible to develop a configuration implementing comparison with sRGB standard values (i.e. standard values regarding the RGB color space) in Step 8 while precluding Step 4 from Steps 1 to 8.

In the foregoing embodiment, the MPU 32 calculates a difference between the reference value stored in the first storage unit 23 and the converted value of the measured value of the simple sensor 10b, thus determining whether or not the calculated difference is equal to or less than the threshold stored in the second storage unit 24. In order to calculate the difference, it is possible to calculate a vertex variation (i.e. a distance between vertexes) of a triangle representing the color gamut of the display device 100, thus using it for failure determination.

FIG. 4 is a graph two-dimensionally plotting xy values (x and y values) shown in FIGS. 2 and 3.

FIG. 4 shows a triangle (i.e. the color gamut of the display device 100) with vertexes corresponding to x and y variations (xy values) in the output of the sensor 10 (i.e. the reference sensor 10a and the simple sensor 10b) applied to the display device 100 displaying three primary colors R, G, and B.

The MPU 32, which calculates distances between vertexes with respect to three primary colors R, G, and B, is configured to output a control signal, for notifying a user of an abnormality of the simple sensor 10b, to the OSD function part 35 when the calculated value is greater than the preset color gamut variation (or an allowable variation) of the second storage unit.

The method for expressing the XYZ ratio output from the color sensor is not necessarily univocal. The present invention is applicable to any other expression methods, other than xy values of the CIE1931 standard described above, such as u′v′ values of the CIE1976 standard, and a, b values of the Lab colorimetric system.

Additionally, it is possible to directly set data to the first storage unit 23 and the second storage unit 24 in the form of XYZ values or in the form of the XYZ ratio.

Normally, display devices are corrected using a color sensor connected to a personal computer and control software installed in a personal computer. Therefore, it is possible to reconfigure the present invention as software separated from a display device.

As described above in the foregoing embodiments, it is possible to output an alert to a user of a display device as to whether or not a simple sensor, which is used to perform color correction on a display device, produces an output value significantly different from the preset reference value due to a colorimetric error thereof. For this reason, it is advantageous for a user of a display device to determine the availability of a simple sensor.

### INDUSTRIAL APPLICABILITY

The foregoing display device is applicable to industries requiring display devices performing stable color reproduction, e.g. graphic design, printing offices, and medical display fields.

### REFERENCE SIGNS LIST

100 display device
10 sensor
10a reference sensor
10b simple sensor
21 operation part
22 communication part
23 first storage unit
24 second storage unit
30 control unit
32 MPU
33 video signal controller
LUT lookup table
34 backlight controller
35 OSD function part
40 liquid crystal display
41 backlight drive unit
42 LCD drive unit
Rg1 first register
Rg2 second register
Rg3 third register

What is claimed is:

1. A display device comprising:
a reference value storage unit which stores a reference value of color gamut resulting from measurement of primary colors displayed on a screen by use of a reference color sensor reference;
a difference calculation part which calculates a difference between a measured value of color gamut resulting from a correcting color sensor, measuring primary colors displayed on the screen and the reference value of color gamut stored in the reference value storage unit; and
an output part which outputs an alert to notify an abnormality of the correcting color sensor when the difference between the measured value of color gamut and the reference value of color gamut becomes equal to or greater than a predetermined threshold.

2. The display device according to claim 1, wherein the reference color sensor and the correcting color sensor are each designed to measure displayed colors on the screen so as to output X, Y, and Z values based on an XYZ colorimetric system of CIE1931, and wherein the measured value of color gamut and the reference value of color gamut are each defined as a ratio of X, Y, Z values based on which is the X, Y, and Z.

3. A control method for a display device which outputs an alert to notify an abnormality of a correcting color sensor, the control method for the display device comprising:
measuring primary colors displayed on a screen by use of a reference color sensor, thus storing a reference value of color gamut in a reference value storage unit;
calculating a difference between a measured value of color gamut resulting from a correcting color sensor measuring primary colors displayed on the screen and the reference value of color gamut stored in the reference value storage unit; and
putting out an alert to notify an abnormality of the correcting color sensor when the difference between the measured value of color gamut and the reference value of color gamut becomes equal to or greater than a predetermined threshold.
